(19) United States
(12) Patent Application Publication
(10) Pub. No.: US 2010/0203743 A1
(43) Pub. Date: Aug. 12, 2010

(54) CONNECTION METHOD FOR FLEXIBLE BOARD AND A FLEXIBLE BOARD CONNECTOR

(75) Inventor: Hongxue Zhang, Julkujarvi (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/678,233

(22) PCT Filed: Sep. 20, 2007
(86) PCT No.: PCT/IB07/02722

§ 371 Date: Mar. 15, 2010

(51) Int. Cl. H01R 12/24; H01R 13/62

(52) U.S. Cl. 439/62; 439/260

(57) ABSTRACT

The present invention suggests a flexible board connector having a frame element, which comprises an insertion opening, and a cover element. The frame element is provided and intended for being mounted to a circuit board. The insertion opening is provided and adapted to accept a flexible board, which has at least one conductive contact on a first side thereof. The cover element has at least an opened position and a closed position. When the cover element is in the closed position, the cover element is adapted for exerting a pressure against a second surface of the flexible board, when the flexible board is inserted through the insertion opening into the frame element of the flexible board connector.

The present invention in general relates to a method for electrically connecting one or more contacts of a flexible board to one or more contacts of a circuit board, a flexible board connector and a connector structure.

In recent years, electronic devices of portable telephones, video cameras and the like have been promoted reducing their size and weight while internally included many built-in electronic components. Many of the electronic components have leads and terminals electrically connected with solder to component mounting lands arranged on a circuit board. In portable telephones, of which the size reduction has been promoted, even comparatively large components such as LCD modules and keypads are arranged on a circuit board, and a plurality of such circuit boards are normally employed. In order to electrically connect the plurality of circuit boards with one another, many flexible boards are employed. Moreover, flexible boards are employed to electrically connect other parts of camera modules and so on to the circuit board.

However, known flexible board connectors suffer significant disadvantages. The present invention provides a new connection method and a flexible board connector making use of the method.

According to a first exemplary aspect of the present invention, a flexible board connector is provided, which comprises a frame element, which has an insertion opening, and a cover element. The frame element is provided and intended for being mounted to a circuit board. The insertion opening is provided and adapted to accept a flexible board, which has at least one conductive contact on a first side thereof. The cover element has at least an opened position and a closed position. When the cover element is in the closed position, the cover element is adapted for exerting a pressure against a second surface of the flexible board, when the flexible board is inserted through the insertion opening into the frame element of the flexible board connector.

According to an exemplary embodiment of the present invention, the at least one conductive contact on the flexible board is arranged against at least one conductive contact on the circuit board, when the cover element is arranged in closed position. In particular, the at least one conductive contact on the flexible board is arranged in touching contact with the at least one conductive contact on the circuit board, and more particularly, at least one conductive contact on the flexible board is pressed against at least one conductive contact on the circuit board.

According to an exemplary embodiment of the present invention, in the closed position, the cover element is adapted for detachably retaining the flexible board in the flexible board connector by exerting the pressure onto the second surface of the flexible board such that the at least one conductive contact of the flexible board and the at least one conductive contact of the circuit board facing each other are pressed against each other, which causes the conductive contacts to get into electric connectivity with each other and to effect a retention force against a pulling actuation on the flexible board, which might cause removing the flexible board from the flexible board connector.

According to an exemplary embodiment of the present invention, the circuit board has at least one conductive contact or a plurality of conductive contacts. The frame element is arranged on the circuit board to house the conductive contacts thereon. The one or more conductive contacts of the circuit board are firmly arranged thereon.

According to an exemplary embodiment of the present invention, the flexible board has at least one conductive contact or a plurality of conductive contacts. The one or more conductive contacts of the flexible board are firmly arranged thereon.

According to an exemplary embodiment of the present invention, the one or more conductive contacts of the flexible board are arranged thereon in a predefined arrangement, which substantially conforms to an arrangement of the one or more conductive contacts of the circuit board. In particular, the one or more conductive contacts of the flexible board and the one or more conductive contacts of the circuit board are respectively arranged in patterns substantially coinciding witch each other.

According to an exemplary embodiment of the present invention, the one or more conductive contacts of said circuit board and the one or more conductive contacts of said flexible board have substantially congruent or coincident surfaces. In particular, the congruent or coincident surfaces of the respective conductive contacts facing each other, when the flexible board is inserted into the flexible board connector, form a substantially common 2-dimensional extended contact surface, within which the respective facing conductive contacts of the circuit board and the flexible board are in electric contact with each other. More particularly, the 2-dimensional electric contact surface ensures at least a low or substantially negligible low contact resistance between the conductive contacts in electrical contact with each other.

According to an exemplary embodiment of the present invention, the pressure is caused by a force exerted onto the second surface of the flexible board, which force has at least a normal force component relative to the second surface.

According to an exemplary embodiment of the present invention, the second surface is opposite to the first surface at which the one or more conductive contacts are arranged.

According to an exemplary embodiment of the present invention, the cover element is pivotably attached to the frame element. The cover element is pivotable into the closed position, in which the flexible board is retained in the flexible board connector.

According to an exemplary embodiment of the present invention, the flexible board connector further comprises a resilient element. Upon deformation of the resilient element the pressure is exerted onto the second surface of the flexible board.

According to an exemplary embodiment of the present invention, the flexible board connector further comprises a bead element. The bead element is provided to accept a pressure exerted by a resilient element and the bead element is further provided to exert a substantially uniformed pressure onto the second surface of the flexible board upon experiencing the pressure exerted by the resilient element.

According to an exemplary embodiment of the present invention, the cover element has at least a deformable portion. When deformed the deformable portion causes a restoring force effecting the pressure exerted onto the flexible board.

According to an exemplary embodiment of the present invention, the cover element has a portion being substantially U-shaped and having at least one deformable leg. When deformed the portion causes a restoring force effecting the pressure exerted onto the flexible board.

According to an exemplary embodiment of the present invention, the flexible board connector further comprises a locking element. The locking element is adapted for releasably locking the cover element in closed position, when the locking element is in engagement with the cover element, in particular when the locking element is in mechanical engagement with the cover element.

According to an exemplary embodiment of the present invention, the flexible board connector further comprises one or more fixing elements. The fixing elements are provided for being firmly mounted to the circuit board and mechanically engaging the frame element such that the frame is firmly mounted to the circuit board.

According to an exemplary embodiment of the present invention, the cover element substantially flushes with the frame element when in closed position.

According to a second exemplary aspect of the present invention, an electronic device is provided, which comprises at least one circuit board with a flexible board connector, which is adapted to accept a flexible board. The circuit board has at least one conductive contact. The flexible board has at least one conductive contact arranged on a first side thereof. The flexible board connector includes a frame element, which has an insertion opening, and a cover element. The frame element is provided and intended for being mounted to a circuit board. The insertion opening is provided and adapted to accept a flexible board. The cover element has at least an opened position and a closed position. When the cover element is in the closed position, the cover element is adapted for exerting a pressure against a second surface of the flexible board, when the flexible board is inserted through the insertion opening into the frame element of the flexible board connector.

According to a third exemplary aspect of the present invention, a method is provided, which comprises providing a frame element and a cover element of a flexible board connector. The frame element is mounted to a circuit board and has an insertion opening. The insertion opening is adapted for accepting a flexible board. The flexible board has at least one conductive contact on a first side of the flexible board. The cover element is cooperative with the frame element and has at least an open and closed position. The flexible board is inserted into the frame element and the cover element is arranged with the frame element in the closed position such that a pressure is exerted against a second side of the flexible board.

According to an exemplary embodiment of the present invention, the at least one conductive contact on the flexible board is arranged against at least one conductive contact on the circuit board, when the cover element is arranged in closed position.

According to an exemplary embodiment of the present invention, the frame element is arranged on the circuit board such that one or more conductive contacts of the circuit board are housed by the frame element. The one or more conductive contacts of the circuit board are thinly arranged thereon. The one or more conductive contact of the flexible board are provided in an arrangement confirming to an arrangement of the at least one conductive contact of the circuit board. The one or more conductive contacts of the flexible board are firmly arranged thereon.

According to an exemplary embodiment of the present invention, the pressure is caused by exerting a force onto the flexible board. In particular, the exerted force has at least a normal force component relative to the second surface.

According to an exemplary embodiment of the present invention, wherein the cover element is pivotably attached to the frame element. The cover element is pivoted into the closed position, in which the flexible board is retained in the flexible board connector.

According to an exemplary embodiment of the present invention, a resilient element is provided and the resilient element is deformed to cause the pressure exerted onto the flexible board.

According to an exemplary embodiment of the present invention, a bead element is provided, which is adapted to accept the exerted pressure; and the bead element is used to exert a uniformed pressure onto the flexible board.

According to an exemplary embodiment of the present invention, the cover element has at least a deformable portion. The at least one deformable portion is deformed such that a restoring force is caused, which effects the pressure exerted onto the flexible board.

According to an exemplary embodiment of the present invention, wherein the cover element has a portion being substantially U-shaped and at least one deformable leg. The at least one deformable leg is deformed such that a restoring force is caused, which effects the pressure exerted onto the flexible board.

According to an exemplary embodiment of the present invention, a locking element is provided. The locking element is engaged with the cover element in the closed position and the cover element is releasably locked in the closed position.

According to an exemplary embodiment of the present invention, one or more fixing elements are provided, which are firmly mounted to the circuit board and mechanically engage with the frame element.

These and other additional objects and features of the present invention will become readily apparent when the same are set forth in greater detail in the accompanying detailed description of the embodiments with reference being made to the drawings in which like reference numerals represent like or similar parts throughout and in which:

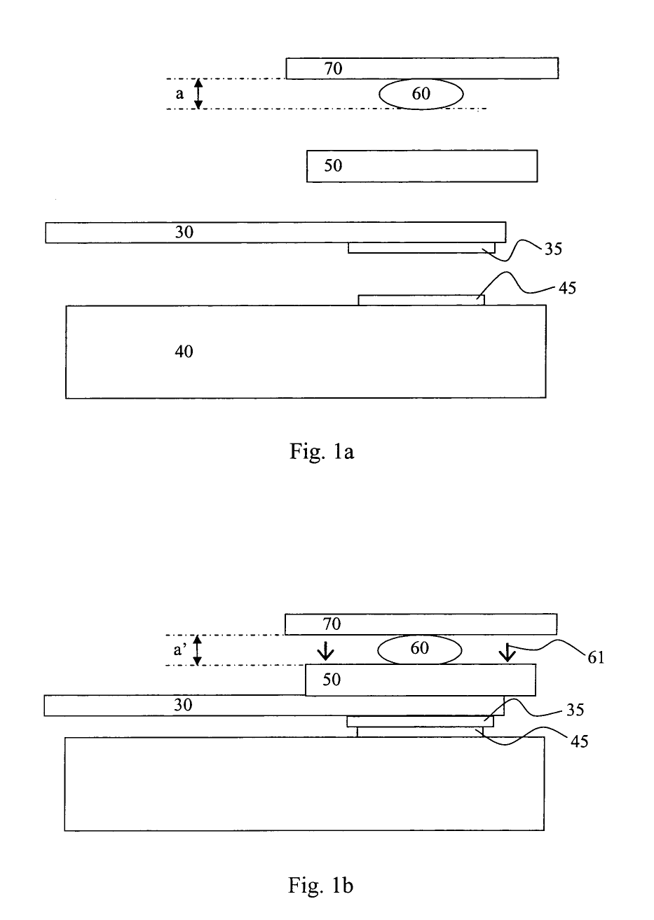

FIG. 1a is a schematic exploded view showing principle components of a flexible board connector 1 according to an exemplary embodiment of the present invention;

FIG. 1b is a further schematic view showing the principle components of FIG. 1 in cooperation with each other according to an exemplary embodiment of the present invention;

FIG. 1c shows different exemplary shapes of conductive contacts according to exemplary embodiments of the present invention;

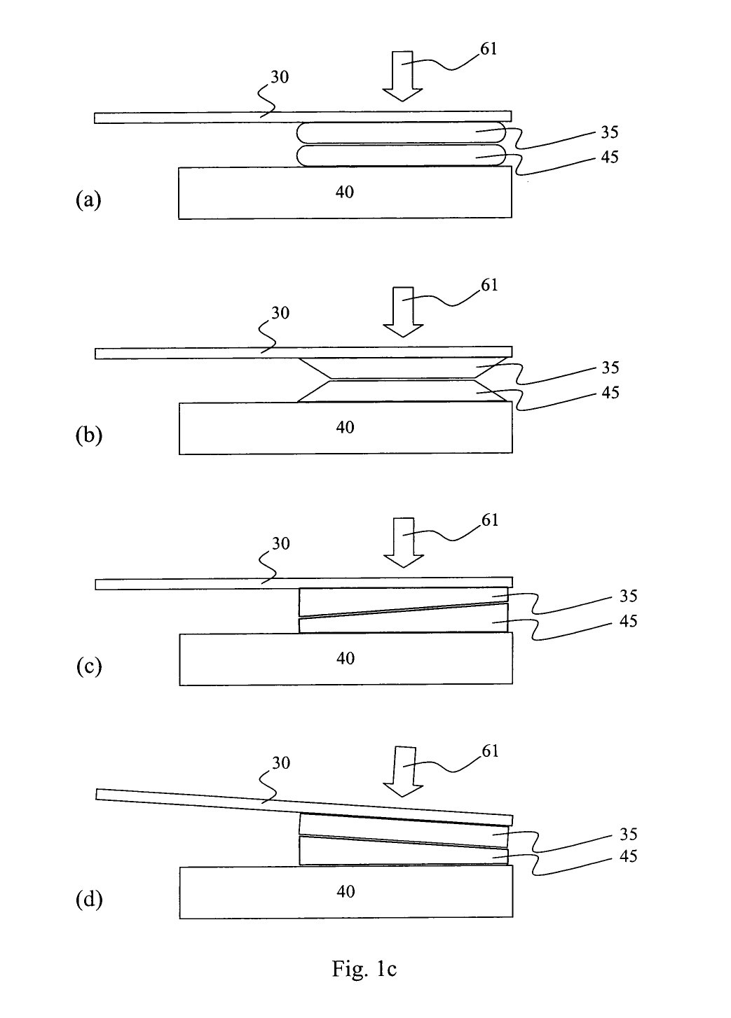

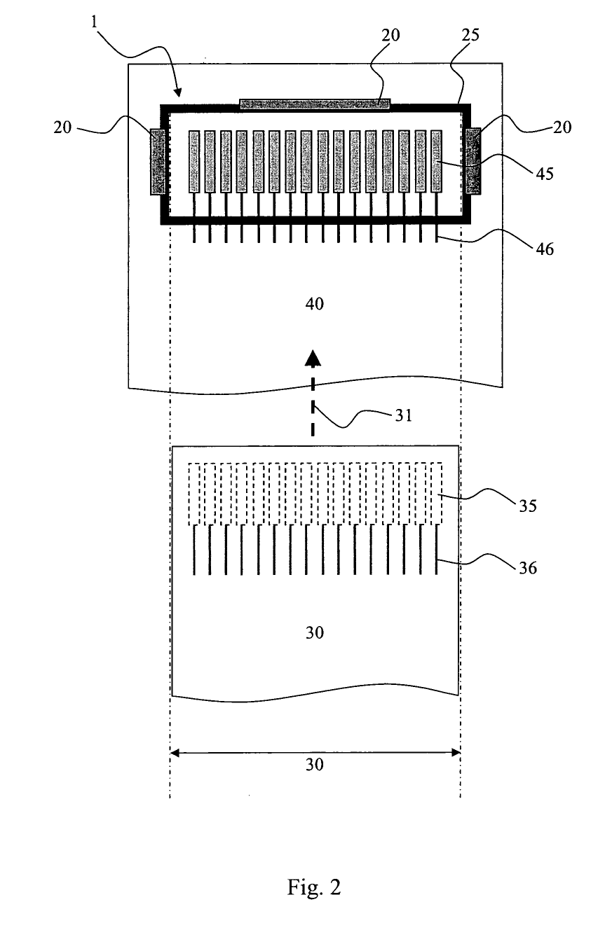

FIG. 2 is a schematic plan view of the flexible board connector mounted on the circuit board for detachably retaining the flexible board according to an exemplary embodiment of the present invention;

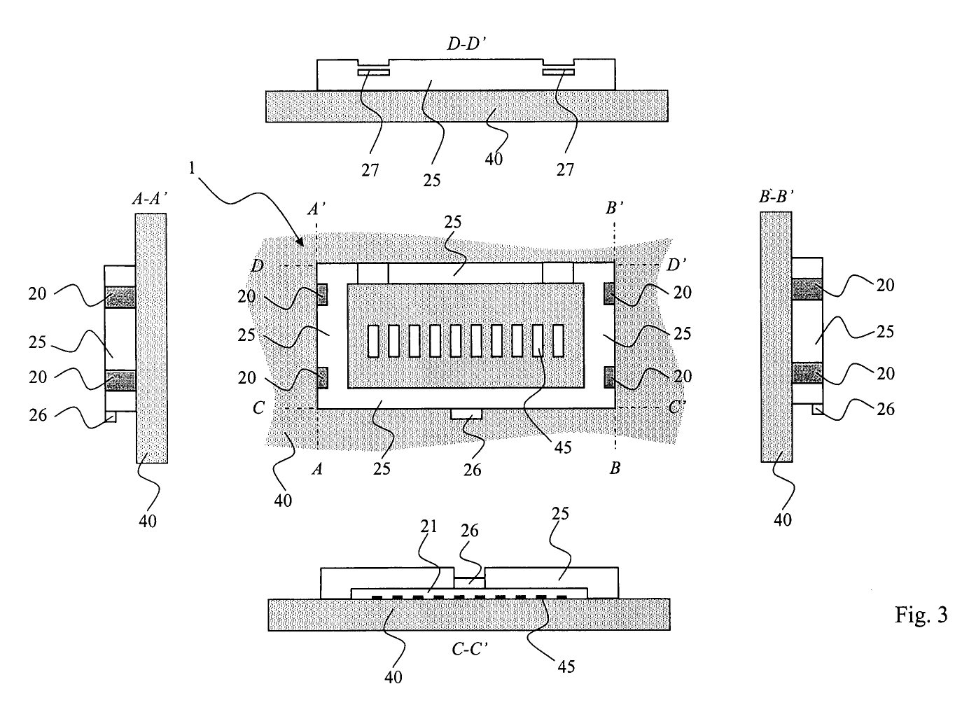

FIG. 3 shows plan and side view of the flexible board connector mounted on the circuit board for detachable retaining the flexible board according to an embodiment of the present invention;

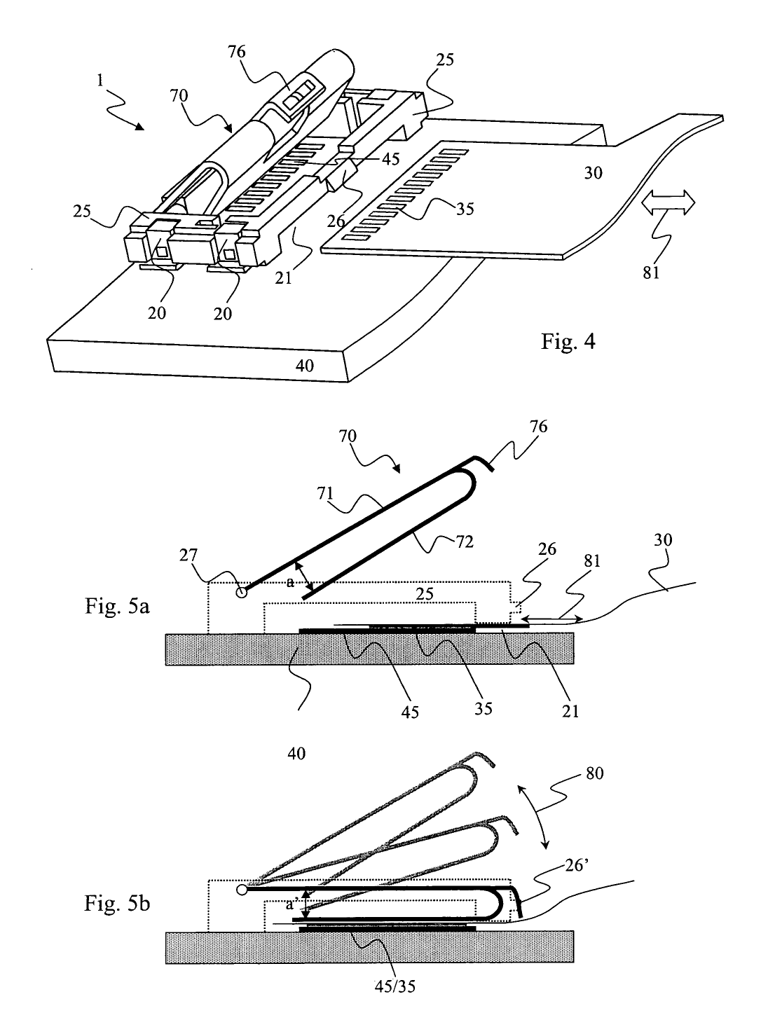

FIG. 4 is a perspective view of a flexible board connector according to an exemplary embodiment of the present invention;

FIG. 5a is a schematic view of the flexible board connector of FIG. 4 illustrating the cooperation of the components of the flexible board connector;

FIG. 5b is another schematic view of the flexible board connector of FIG. 4 illustrating the cooperation of the components of the flexible board connector;

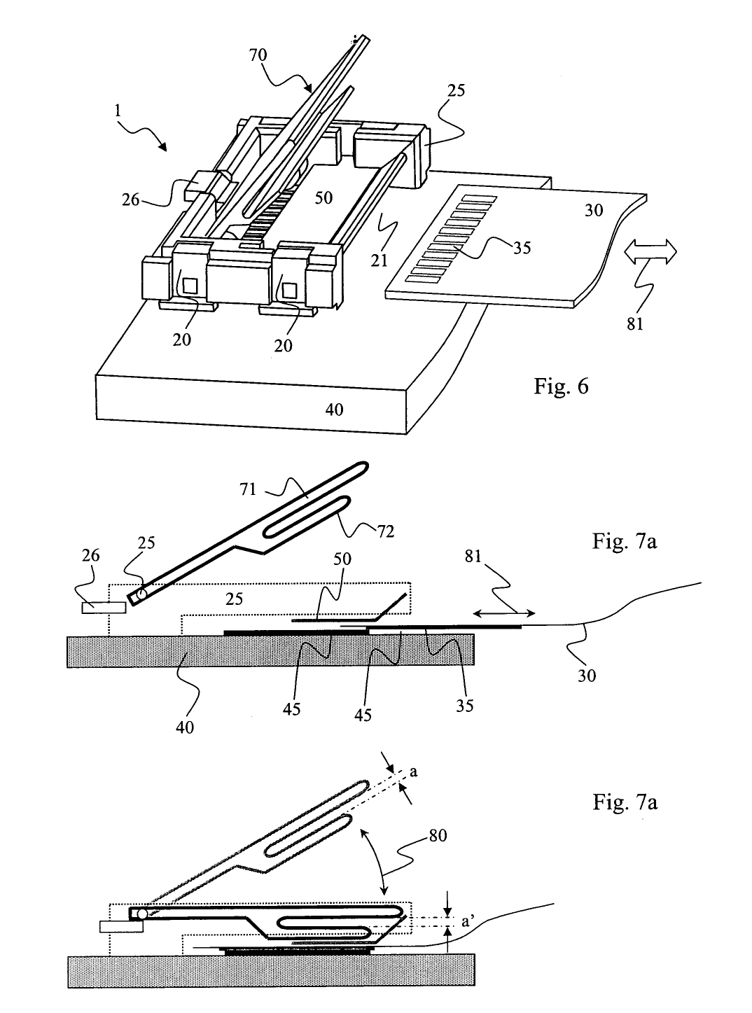

FIG. 6 is a perspective view of another flexible board connector according to an exemplary embodiment of the present invention;

FIG. 7a is a schematic view of the flexible board connector of FIG. 6 illustrating the cooperation of the components of the flexible board connector; and

FIG. 7b is another schematic view of the flexible board connector of FIG. 6 illustrating the cooperation of the components of the flexible board connector.

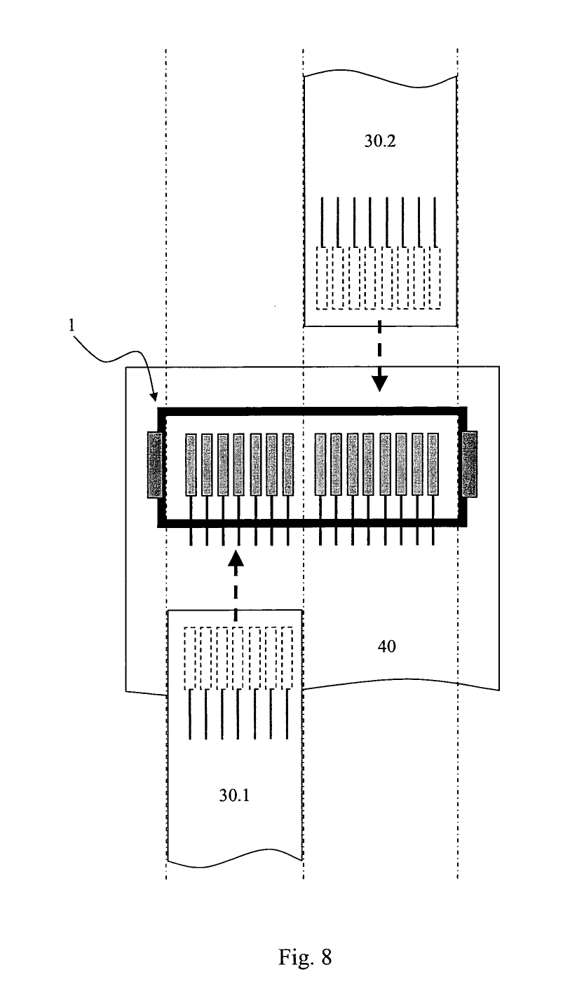

FIG. 8 is a schematic plan view of the flexible board connector mounted on the circuit board for detachably retaining the flexible board according to an exemplary embodiment of the present invention.

The present invention will be described in detail below on the basis of exemplary embodiments shown in the drawings.

The following embodiments are described in sufficient detail to enable those skilled in the art to practice the invention, and it is to be understood that the embodiments may be combined, or that other embodiments may be utilized and that structural, logical, and electrical changes may be made without departing from the spirit and scope of the present invention. It should be noted that references to “an”, “one”, or “various” embodiments in this document are not necessarily to the same embodiment, and such references contemplate more than one embodiment.

FIG. 1a shows an exploded view of principle components of a flexible board connector 1 according to an exemplary embodiment of the present invention. The flexible board connector 1 is provided for detachable retaining or fixing a flexible board 30 to a circuit board 40 and electrically connects the wiring of the flexible board 30 to the circuit of the circuit board 40.

The circuit board 40 has a plurality of conductive contacts 45 for electrically connecting the circuit of the circuit board 40 to the wiring of the flexible board 30. The conductive contacts 45 of the circuit board 40 are embodied as conductive pads each having a substantially planar conductive surface.

The flexible board 30 has a plurality of conductive contacts 35 for electrically connecting the wiring of the flexible board 30 to the circuit of the circuit board 40. The conductive contacts 35 of the flexible board 30 are embodied as conductive pads each having a substantially planar conductive surface.

The flexible board connector 1 is designed to bring the conductive contacts 45 and the conductive contact 35 into an arrangement, in which the conductive contacts 45 of the circuit board 40 and the conductive contacts 35 of the flexible board 30 are facing each other and in direct contact such that an electrical connection between them is enabled.

The conductive contacts 35 and 45 may be substantially designed as rectangular solids, which project at a predefined height from the surface of the flexible and circuit boards, respectively. The invention should not be understood as being limited to rectangular solids; alternatively shaped conductive contacts 35 and 45 may also be used. However, in order to ensure a reliable electric connection between the contacts 35 and 45 facing each other, the facing surfaces should be substantially planar such that a direct planar electrical contact is formed.

In order to ensure reliable electrical contact a force or pressure (indicated with reference numeral 61 in FIG. 1b) is applied on the back surface of the flexible board 30, which presses the facing conductive surfaces of the conductive contacts 45 of the circuit board 40 and the conductive contacts 35 of the flexible board 30 against each other. The force 61 should be a normal force 61 (i.e. normal in relation to the conductive surface of the contacts 35 and 45) or should be a force 61 having a normal component. Such a normal force may be exerted by a resilient, spring or elastic element 60, which upon deformation exerts a normal force onto at least the region of the flexible board 30, within which the conductive contacts 35 are arranged. A cover element 70 may be used for exerting the deforming force 61 onto the resilient element 60.

The force 61 applied to the resilient element 60 may deform the resilient element starting at a height a, when there is not applied a force thereto, to have a deformed height a′ at a given magnitude of force.

The normal force may be exerted onto the back surface of the flexible board 30, which is the opposite surface to the surface, at which the conductive contacts are arranged.

In order to ensure a substantially uniform pressure exerted onto the conductive contact 35 of the flexible board 30, a bead element 50 may be arranged between the resilient element 60 and flexible board 30 according to an exemplary embodiment of the present invention.

Although the exemplary embodiment illustrates, surfaces of the conductive contact 35 and 45, which are substantially parallel to the surface of the flexible 30 and circuit boards 40, respectively, the invention should not be understood as being limited thereto. The conductive contacts may also have side surfaces substantially perpendicular to the base surface defined by the corresponding board; rounded surfaces (cf. FIG. 1c, exemplary embodiment (a)); side surfaces inclining at predetermined angle(s) in relation to the base surface and titled in direction to each other (cf. FIG. 1c, exemplary embodiment (b)); tapered shapes in side view (cf. FIG. 1c, exemplary embodiment (c)); or any combination thereof such as exemplary embodiment (d) of FIG. 1c, where the conductive contacts 35 have a substantially rectangular shape in side view and the conductive contacts 45 have a substantially tapered shape in side view. According to another exemplary embodiment of the present invention, the surfaces should not be understood as being limited to planar surfaces. The surfaces of the facing conductive contacts (i.e. the respective contacts of the circuit board and the flexible board facing each other, when the flexible board 30 is properly inserted into the flexible board connector 1) may be shaped congruently or coincidently. For instance, one of the surfaces of the respective facing conductive contacts may have convex or substantially spherical shape, whereas the other one may have a congruent concave or inverse spherical shape. More generally, the respective facing conductive contacts may have coincident or congruent shaped surfaces, which ensure a common 2-dimensional extended contact surface of the facing conductive contacts with each other.

A force normal to the surfaces of the conductive contacts 35 and 45 facing each other exert a pressure, which should be substantially uniform such that reliable electric connectivity between the conductive contacts 35 of the flexible board 30 and the conductive contacts 45 of the circuit board is ensured.

In common to all exemplary embodiment described above, the conductive contacts of the circuit board and the flexible board should have one or more (predefined) heights such that the conductive surfaces of the contacts are spaced at defined heights from the surfaces of the circuit and flexible boards. More generally, the conductive contacts of the contacts should project over the surfaces of the respective board. In particular, solder masks around the conductive contacts may be avoided. The projecting contacts guarantee that the respective facing conductive contacts of the circuit board and flexible board can get into direct and 2-dimensional contact without interference by for instance any adjoining elements, which may hinder the getting into contact of the facing conductive contacts of the circuit board and flexible board.

FIG. 2 illustrates a schematic plan view of the flexible board connector mounted on the circuit board according to an exemplary embodiment of the present invention. The flexible board connector 1 is provided for detachably retaining the flexible board and for ensuring reliable electric connectivity between the conductive contacts of the circuit board 40 and the detachably retained flexible board 30, respectively. As schematically indicated in FIG. 2, the conductive contacts 45 are connected to individual wiring 46 of the circuit of the circuit board 40. The conductive contacts 45 may be formed by an etching or corroding process of a conductive surface layer of the circuit board 40. The conductive contacts 45 may also be soldered to the circuit of the circuit board 40, fixed by conductive adhesive substance thereto, or may be firmly attached in any other suitable manner to the circuit of the circuit board 40.

The conductive contacts 35 are connected to individual wiring 36 of the flexible board 30. Further, the conductive contacts 35 may be formed by printing conductive substance onto the flexible board 30. The conductive contacts 35 may also be soldered to the wiring of the flexible board 30, may be fixed by conductive adhesive substance thereto, or may be firmly attached in any other suitable manner to the wiring of the flexible board 30. The conductive contacts 35 may also be formed by an etching or corroding process of a conductive surface layer of the flexible board 30.

The flexible board connector 1 comprises one or more fixing elements 20 and a frame element 25. The fixing elements 20 are designed to couple the flexible board connector 1 to the circuit board 40 and are further designed to carry the frame element 25 of the flexible board connector 1. For instance, the fixing elements 20 may be mechanically mounted, soldered, or glued/adhered to the circuit board 40. For instance, a mechanical mounting may be obtained by riveting, clamping or screwing the fixing element through passages provided in the circuit board 40. Further, the fixing elements 20 may be solder tails for being soldered to the circuit board 40.

According to exemplary embodiments of the present invention, the fixing elements 20 may be provided integral with the frame element 25, the fixing elements 20 and the frame elements 25 may be formed as one piece from the same material, or the frame element 25 and fixing elements 20 may be separate elements. Furthermore, the frame element 25 may mechanically engage the fixing elements 20. In particular, the fame element 25 may be firmly or detachably coupled to the fixing elements 20.Such mechanical engagement may be obtained by clamping or snapping the frame element 25 to the fixing elements 20 such that the frame element is mechanically firmly coupled by the fixing elements 25 to the circuit board 40.

The flexible board connector 1 is designed to accept the flexible board 30, which is for instance inserted, moved or slit into the flexible board connector 1 through an insertion opening in the frame element 25. The size of the insertion opening is adapted to accept the flexible board 30. During insertion the flexible board 30 may be inserted by a movement substantially parallel to the surface of the circuit board 40 facing the flexible board 30.

FIG. 3 illustrates further schematic plan and side views of the flexible board connector according to an exemplary embodiment of the present invention. The centrally depicted illustration shows a schematic plan view of the flexible board connector 1 according to an exemplary embodiment of the present invention. Further schematic side views are depicted, which represent side plan views along the cross sections A-A′, B-B′, C-C′ and D-D′. Each of the side plan views A-A′ and B-B′ illustrating a cross section in short-side direction of the flexible board connector 1 shows two fixing elements 20 and the frame element 25 at least mechanically engaged therewith.

The front plan view C-C′ illustrating a cross section in long-side direction of the flexible board connector 1 shows the insertion opening 21 in the frame element 25, through which the flexible board 30 is inserted into the flexible board connector 1 and through which the flexible board 30 extends. The front portion of the frame element 25 is for example further provided with a projecting element 26, which can be used as a locking element in cooperation with a cover element forming a pressure piece. Such a cover element, which holds or retains an inserted flexible board within the flexible board connector 1 by exerting a normal force or pressure onto the inserted flexible board 30, will be described below in more detail. According to embodiments of the present invention, the cover element is pivotably mounted to the flexible board connector 1. The pivot mechanism enabling the pivoting movement of the cover element may be realized by one or more hinge elements 27 shown in the back plan view D-D′ in long-side direction of the flexible board connector 1. The pivot mechanism allows for pivotably mounting the cover element to the frame element 25.

FIG. 4 is a perspective view showing a flexible board connector 1 of an exemplary embodiment of the present invention. The flexible board connector 1 holds or retains a flexible board 30 to a circuit board 40 and electrically connects the wiring of the flexible board 30 to the circuit of the circuit board 40.

The flexible board connector 1 comprises a plurality of conductive contacts 45 for electrically connecting the circuit of the circuit board 40 to the wiring of the flexible board 30. The flexible board 30 has a corresponding plurality of conductive contacts 35. Each conductive contact 35 of the flexible board 30 is arranged to face a respective conductive contact 45 of the circuit board 40.

The conductive contacts 45 are embodied as conductive pads, each having a substantially rectangular plan view and each having a substantially planar conductive surface arranged for fitting against respective contacts 35 of the flexible board 30, which are also embodied as conductive substantially rectangular pads each having a substantially planar conductive surface. The plurality of contacts 45 may be arranged in the lengthwise direction of the flexible board connector 1 and extend mutually parallel in the short-side direction of the flexible board connector 1 as show in FIG. 4 for the same of illustration.

The plurality of contacts 45 of the circuit board 40 may be arranged in any other 1-dimensional or 2-dimensional pattern. The plurality of contacts 35 of the flexible board 30 should be arranged in a substantially pattern, which matches the pattern of the plurality of contacts 45 of the circuit board 40

The flexible board connector 1 comprises fixing elements 20 such as soldering tails, a frame element 25 provided with an insertion opening 21, and a cover element 70, which acts as force exerting component. The fixing elements 20 may be arranged at the short sides of the frame element 25 of the flexible board connector 1 and more particularly, each short side of the frame element 25 has arranged two fixing elements 20 for the sake of example. The arrangement of the one or more fixing elements 20 should not be understood as limited thereto. This is, the one or more fixing elements 20 may be arranged at any one or more sides of the frame element 25 including in particular the back side thereof (opposite to the side, at which the insertion opening is arranged). The fixing elements 20 are in mechanical engagement with the frame element 25 such that frame element 20 is substantially firmly mounted at the circuit board. The mechanical engagement should be understood to comprise a frame element 25 formed of one piece including integrally the one or more fixing elements 20.

The cover element 70 is pivotably attached to the frame element 25 at the long back side thereof opposite to the long side having the insertion opening 21. In a first opened position, the cover element 70 extends from the frame element 25. By pivoting actuation the cover element 70 is pivoted about an axis defined by one or more hinge elements arranged at the long back side of the frame element 25 and extending in direction of the long side of the frame element 25. In a closed position the cover element 70 substantially flushes with the frame element 25.

In opened position, the flexible board 30 can be inserted into or removed from the flexible board connector 1 through the insertion opening 21. In closed position, the flexible board 30 inserted in the flexible board connector 1 is retained against removal from the flexible board connector 1. The cover element 70 exerts a normal force onto the inserted flexible board 30. The holding mechanism will be described in more detail with reference to the following figures.

The frame element 25 is further provided with a locking element 26, which can engage with the cover element 70 in closed position. The locking element 76 is designed as an opening, recess or aperture, which engages with the counterpart locking element 26 designed as a projection fitting into the opening. The opening is arranged at a handle of the cover element 70. By exerting a deforming force onto the handle or the frame element 25 nearby the projection, the engagement of the opening and the projection can be released.

FIGS. 5a and 5b illustrate schematic views of the flexible board connector 1 embodied above with reference to FIG. 4. For the sake of schematic illustrating a cross sections in short-side direction are depicted in FIGS. 5a and 5b. A side view of the frame element 25 with locking element 26 is schematically depicted by dotted outlines. The cover element 70 is pivotably mounted at the frame element 25. The one or more hinge elements 27 and the pivoting axis, which extends in this side view perpendicular to the view drawing plane, is schematically depicted as a circle.

In FIG. 5a, the cover element 70 is in opened position. The flexible board 30 with the plurality of conductive contacts 35 may be inserted into or removed from the flexible board connector through the insertion opening 21. The inserting or removing direction 81 is substantially parallel to the surface of the circuit board 40.

The cover element 70 has a substantially U-shaped structure including a first leg 71 and a second leg 72. The end portion of the first leg 71 is coupled to the one or more hinge elements 27. In addition, the handle of the cover element 70 with opening 76 is depicted. The U-shaped structure has an opening width a, when the cover element 70 is in opened position. The opening of the U-shaped cover element 70 faces into the direction of the pivoting mechanism, which is herein exemplarily embodied by the one or more hinge elements 27.

As aforementioned, the cover element 70 can be moved into closed position by pivoting 80 about the hinge axis defined by the one or more hinge elements 27. The cover element 70 in closed position is schematically illustrated in FIG. 5b. The cover element 70 substantially flushes with the frame element 25. The projection 26 engages the counterpart opening 76 such that the cover element is locked in closed position. Before closure of the cover element 25, the flexible board 30 has been inserted through the insertion opening 21 of the frame element 25 and brought into position such that the plurality of conductive contacts 45 of the circuit board 40 and the conductive contacts 35 of the flexible board 30 are in confronting and conforming arrangement. This means that the planar conductive surfaces of the contacts 45 of the circuit board 40 and planar conductive surfaces of the contacts 35 of the flexible board 30 face each other and are in planar close contact with each other.

During pivoting actuation of the cover element 70 into closed position, the free leg 72 of the substantially U-shaped cover element 70 gets into planar contact with the back surface of the flexible board 30, which is the opposed surface to the surface being provided with the conductive contacts 35. When the free leg 72 coming into direct contact with the flexible board 30, the free leg 72 is deformed in the direction of the leg 71 coupled to the pivot mechanism. The opening width a between the legs in opened position of the cover element 70 is reduced to an opening width a′ between the legs in closed position. The deformation in the opening width of the U-shaped cover element results in a reactive, restoring force, which is exerted onto the flexible board 30 being in contact with the free leg 72 in closed position. The U-shaped cover element 70 may be designed such that the deformed free leg is in closed position substantially parallel to the back surface of the flexible board 30. Hence, a substantially uniform and normal force is exerted by the deformed free leg 72 onto the back surface of the flexible board, which results in a substantially uniform pressure exerted by the contact surfaces of the conductive contacts 35 of the flexible board 30 onto the contact surfaces of the conductive contacts 45 of the circuit board 40. The normal pressure ensures a reliable electrical connectivity between each adjoining pair of conductive contacts 45 and conductive contacts 35. Further, the normal pressure ensures a retaining of the flexible board 30 inserted in the flexible board connector 1 against extraction or removing forces.

It should be noted that the design of a cover element 70 having substantially the aforementioned U-shape may be subjected to material and geometry restrictions. For instance, the size of free leg may have such an extent that a substantially uniform and normal force exerted by the deformed free leg 72 onto the back surface of the flexible board cannot be ensured. Although, the deformed free leg may be substantially parallel to the back surface in closed position, the force exerted by the deformed free leg thereon may be non-uniform. Only within an area of small size may be in closed linkage with the back surface of the flexible board. In this case, a bead element may be used, which accepts the force exerted by the cover element onto any area of the bead element. The bead element transfers the force exerted thereon onto the back surface of the flexible board. The properties of the bead element are selected such that the force exerted thereon is uniformed and the force transferred by the bead element onto the back surface of the flexible board is exerted by a uniformed pressure substantially uniform over the area of contact between bead element and back surface of the flexible board. The use of a bead element may also reduce the risk that force exerted by the cover element causes distortion/deformation of all other elements including in particular the boards such that electric contact between the conductive contacts may be at least degraded or lost. The bead element should have suitable material properties including for instance substantially rigid and/or buckling resistant properties, which can ba obtained by adequate material selection and/or shape design of the bead element. The use of a bead element is illustratively explained with reference to the FIG. 6. However, such a bead element may be also used in the exemplary embodiment of FIG. 4, whereas the exemplary embodiment of FIG. 6 may also be implemented without bead element.

The normal force or pressure, which is exerted by the conductive contacts of the flexible board 30 onto the conductive contacts of the circuit board 40, can be adapted by selection of material, of which the cover element 70 is made, and the geometry of the legs 71 and 72 of the cover element. A more stiff material, of which the legs of the cover element 70 are made, results in a higher force exerted onto the flexible board 30 and hence pressure exerted by the conductive contacts 35 of the flexible board 30 onto the conductive contacts 45 of the circuit board 40. The cover element 70 may be made of metal or any other deformation resistant material including in particular polymeric materials.

Because the conductive contacts of the circuit hoard 40 and the flexible board 30 are realized by contact pads, which are directly and firmly provided on the respectively boards, fine pitches of the contact pads for instance in the range of 0.3 mm to 0.2 mm or below can be realized. Typical contact springs as known in the art are not required for realizing the electrical connection between circuit board and flexible board. The requirement of contact spring limits significantly an economic downsizing of the pitch.

The frame element 25, which forms the housing of the flexible board connector 1, may be made of any material including polymeric materials and metals. A metallic frame element 25 of the flexible board connector 1 may provide an effective shielding of undesired electromagnetic radiation.

FIG. 6 is a perspective view showing another flexible board connector 1 of an exemplary embodiment of the present invention. Again, the flexible board connector 1 holds or fixes a flexible board 30 to a circuit board 40 and electrically connects the wiring of the flexible board 30 to the circuit of the circuit board 40.

The flexible board connector 1 comprises a plurality of conductive contacts 45 for electrically connecting the circuit of the circuit board 40 to the wiring of the flexible board 30. The flexible board 30 has a corresponding plurality of conductive contacts 35. Each conductive contact 35 of the flexible board 30 is arranged to face a respective conductive contact 45 of the circuit board 40.

The conductive contacts 45 are embodied as conductive pads, each having a substantially rectangular plan view and each having a substantially planar conductive surface arranged for fitting against respective contacts 35 of the flexible board 35, which are also embodied as conductive substantially rectangular pads each having a substantially planar conductive surface. The plurality of contacts 45 are arranged in the lengthwise direction of the flexible board connector 1 and extend mutually parallel in the short-side direction of the flexible board connector 1.

The flexible board connector 1 comprises also fixing elements 20 such as soldering tails, a frame element 25 provided with an insertion opening 21, and a cover element 70, which acts as force exerting component. The fixing elements 20 are arranged at the short sides of the frame element 25 of the flexible board connector 1. Herein, each short side of the frame element 25 has arranged two fixing elements 20. The fixing elements 20 are in mechanical engagement with the frame element 25 such that frame element 20 is substantially firmly mounted at the circuit board. The cover element 70 is pivotably attached to the frame element 25 at the long back side thereof opposite to the long side having the insertion opening 21. In a first opened position, the cover element 70 extends from the frame element 25. By pivoting actuation the cover element 70 is pivoted about an axis defined by one or more hinge elements (not shown) arranged at the long back side of the frame element 25 and in direction of the long side of the frame element 25 such that in a closed position the cover element 70 substantially flushes with the frame element 25.

In opened position, the flexible board 30 can be inserted into or pulled out from the flexible board connector 1 through the insertion opening 21. In closed position, the flexible board 30 inserted in the flexible board connector 1 is retained against removal therefrom. The cover element 70 exerts a normal force onto the inserted flexible board 30. The holding mechanism will be described in more detail with reference to the following figures.

The frame element 25 is provided with a locking mechanism 26, which can be used to block the pivoting movement of the cover element 70 in closed position. The lock mechanism 26 in engagement with the cover element 70 firmly holds the cover element 70 in the closed position.

Additionally, a bead element 50 is arranged between the cover element 70 in closed position and the flexible board 30 inserted into the flexible board connector 1. The bead element 50 is provided to accept the pressing force exerted by the cover element 70 in closed position onto the bead element 50. The substantially planar bead element 50 ensures that the pressing force is substantially uniformly distributed among the conductive contacts 35 of the flexible board 30 such that a substantially uniform pressure is exerted by the conductive contacts 35 of the flexible board 30 onto the conductive contacts 45 of the circuit board 40.

FIGS. 7a and 7b illustrate schematic views of the flexible board connector 1 embodied above with reference to FIG. 6. For the sake of schematic illustrating a cross sections in short-side direction are depicted in FIGS. 7a and 7b. A side view of the frame element 25 with locking element 26 is schematically depicted by dotted outlines. The cover element 70 is pivotably mounted at the frame element 25. The one or more hinge elements 27 and the pivoting axis, which extends in this side view perpendicular to the view drawing plane, is schematically depicted as a circle.

In FIG. 7a, the cover element 70 is in opened position. The flexible board 30 with the plurality of conductive contacts 35 may be inserted into or removed from the flexible board connector 1 through the insertion opening 21. The inserting or removing direction 81 is substantially parallel to the surface of the circuit board 40.

The cover element 70 has a substantially U-shaped structure including a first leg 71 and a second leg 72. The end portion of the first leg 71 is coupled to the one or more hinge elements 27. The U-shaped structure has an opening width a, when the cover element 70 is in opened position. The opening of the U-shaped cover element 70 faces into the direction of the insertion opening 21, when the cover element 70 is in closed position.

As aforementioned, the cover element 70 can be moved into closed position by pivoting 80 about the hinge axis defined by the one or more hinge elements 27. The cover element 70 in closed position is schematically illustrated in FIG. 7b. The cover element 70 substantially flushes with the frame element 25. The projection 26 can engaged with the first leg 71 such that the cover element can locked in closed position and prevented by the projection 26 from pivoting into opened position. The projection 26 may be moved into locking position by movement in a direction parallel to direction, in which the first leg 71 extends, when in closed position. Before closure of the cover element 70, the flexible board 30 has been inserted through the insertion opening 21 of the frame element 25 and brought into position such that the plurality of conductive contacts 45 of the circuit board 40 and the conductive contacts 35 of the flexible board 30 are in confronting and conforming arrangement. Herein the insertion opening 21 is defined by the bead element 50 having an inclined portion in the direction of the insertion opening 21. The planar conductive surfaces of the contacts 45 of the circuit board 40 and planar conductive surfaces of the contacts 35 of the flexible board 30 face each other and are in planar close contact with each other.

During pivoting actuation of the cover element 70 into closed position, the free leg 72 of the substantially U-shaped cover element 70 gets into contact with the bead element 50, which in turn is forced into substantially planar contact with the back surface of the flexible board 30, which is the opposed surface to the surface having attached the conductive contacts 35. The bead element 50 arranged movably or slidably in normal direction, i.e. in the direction substantially perpendicular to the surface of the flexible board 30. Upon the free leg 72 coming into direct contact with the bead element 50, the free leg 72 is deformed in the direction of the leg 71 coupled to the pivot mechanism. The opening width a between the legs in opened position of the cover element 70 is reduced to an opening width a′ between the legs in closed position. The deformation in the opening width of the U-shaped cover element results in a reacting or restoring force, which is exerted onto the bead element 50, which substantially uniformly passes on the exerted force onto the flexible board 30 being in substantially planar contact with the bead element 50 in closed position. The slidable or movable arrangement of the bead element 50 allows for substantially informing the force with respect to the surface area of the bead element 50. This means a force which is exerted for instance punctually or linearly onto the bead element 50 is accepted thereby and exerted over the overall surface area to the flexible board 30 arranged below.

The U-shaped cover element 70 is designed such that the deformed free leg is in closed position to the bead element 50. Hence, a substantially normal force is exerted by the deformed free leg 72 onto the bead element 50, which normal force is uniformed by the bead element 50, which has freedom to slide in a direction substantially perpendicular to the contact surface of the flexible board 30. The normal uniformed force is passed onto the flexible board 30, which results in a substantially uniform pressure exerted by the contact surfaces of the conductive contacts 35 of the flexible board 30 onto the contact surfaces of the conductive contacts 45 of the circuit board 40. The normal pressure ensures a reliable electrical connectivity between each adjoining pair of conductive contacts 45 and 35. Further, the normal pressure ensures a retaining of the flexible board against removal forces within the flexible board connector 1.

The normal force or pressure, which is exerted by the conductive contacts 35 of the flexible board 30 onto the conductive contacts 45 of the circuit board 40, can be adapted by selection of the material the cover element 70 and the geometry of the cover element 70. A more stiff material, of which the legs of the cover element 70 are made, results in a higher force exerted onto the flexible board 30 and hence pressure exerted by the conductive contacts 35 of the flexible board 30 onto the conductive contacts 45 of the circuit board 40. The cover element 70 may be made of metal or any other deformation resistant material including in particular polymeric materials.

In general it should be noted that the deformation should be within the maximal limits of deformation acceptable by the selected material of the cover element 70. Exceeding the maximum limits of deformation may result in a weakening of the cover element 70 for instance due to micro cracks and fatigue of material or even in a fracture of the cover element 70.

It should be also noted that the suggested flexible board connector 1 having a resilient element provided to exert a pressure force pressing the conductive contacts of the flexible board and the conductive contacts of the circuit board such that the electrical connectivity between the adjoining contacts is ensured and retaining of the flexible board from the flexible board connector is prevented. The resilient element and in particular the cover elements embodied above can be designed such that the flexible board connector accepts flexible boards with a wide range of thinness of flexible boards.

As shown in FIG. 8, the flexible board 30 according to an exemplary embodiment of the present invention has an end shape such that it is partially cut away from the center in the widthwise direction. Both of the two flexible boards 30.1 and 30.2 have the substantially same overall shape. As shown in FIG. 8, the end portion of the flexible board 30.1 located on one side of the flexible board connector 1 is inserted into the flexible board connector 2 through an insertion opening in the frame element at the corresponding side thereof. Moreover, the end portion of the flexible board 30.2 located the other opposite side of the flexible board connector 1 is inserted into the flexible board connector 1 through an insertion opening in the frame element at the corresponding side thereof.

From the forgoing description, it will be apparent that modifications can be made to the system without departing from the teaching of the present invention. Accordingly, the scope of the invention is only to be limited as necessarily by the accompanying claims.

1-34. (canceled)

35. An apparatus comprising:
a flexible board connector, said flexible board connector comprising:
a frame element configured for being mounted with a circuit board, said frame element having an insertion opening configured for accepting a flexible board, said flexible board having at least one conductive contact on a first side of said flexible board; and
a cover element having at least an open and closed position, said cover element in said closed position configured to exert pressure against a second side of said flexible board when said flexible board is inserted into said frame element.

36. An apparatus according to claim 35, wherein the cover element is configured to retain the at least one conductive contact on said flexible board in contact with at least one conductive contact on said circuit board when said cover element is in said closed position.

37. An apparatus according to claim 35, wherein the cover element is configured to exert a force onto said flexible board when said cover element is in said closed position.

38. An apparatus according to claim 35, wherein said cover element is pivotably attached to said frame element and said cover element is pivotable into said closed position, in which said flexible board is retained in said flexible board connector.

39. An apparatus according to claim 35, further comprising a resilient element wherein said pressure is exerted onto said second surface of said flexible board when said resilient element is deformed.

40. An apparatus according to claim 35, further comprising a bead element configured to receive said pressure and to exert pressure onto said second surface of said flexible board.

41. An apparatus according to claim 35, wherein said cover element has at least a deformable portion, which when deformed causes a restoring force effecting said pressure exerted onto said second surface of said flexible board.

42. An apparatus according to claim 35, wherein said cover element has a portion being substantially U-shaped and at least one deformable leg, which when deformed causes a restoring force effecting said pressure exerted onto said second surface of said flexible board.

43. An apparatus according to claim 35, wherein said cover element substantially flushes with said frame element when in closed position.

44. An apparatus, comprising:
at least one circuit board having at least one conductive contact;
at least one flexible board having at least one conductive contact on a first side of said flexible board; and
a flexible board connector comprising:
a frame element configured for being mounted to said circuit board, said frame element having an insertion opening for accepting said flexible board; and
a cover element having at least an open and closed position,
said cover element configured to exert pressure against a second side of said flexible board when said flexible board is inserted into said frame element when said cover element is in said closed position.

45. An apparatus according to claim 44, wherein said at least one conductive contact on said flexible board is arranged against at least one conductive contact on said circuit board when said cover element is in said closed position.

46. An apparatus according to claim 44, wherein said at least one conductive contact of said circuit board and said at least one conductive contact of said flexible board have substantially congruent conductive surfaces.

47. An apparatus according to claim 44, wherein said pressure is caused by a force exerted onto said flexible board having at least a normal force component relative to said second surface.

48. An apparatus according to claim 44, wherein said cover element is pivotably attached to said frame element, wherein said cover element is pivotable into said closed position, in which said flexible board is retained in said flexible board connector when said cover element is in said closed position.

49. An apparatus according to claim 44, further comprising a resilient element, wherein said pressure is exerted onto said second surface of said flexible board when said resilient element is deformed.

50. An apparatus according to claim 44, further comprising a bead element configured for accepting said pressure and exerting a uniformed pressure onto said second surface of said flexible board.

51. An apparatus according to claim 44, wherein said cover element has at least a deformable portion, which when deformed causes a restoring force effecting said pressure exerted onto said second surface of said flexible board.

52. An apparatus according to claim 44, wherein said cover element has a portion being substantially U-shaped and at least one deformable leg, which when deformed causes a restoring force effecting said pressure exerted onto said second surface of said flexible board.

53. An apparatus according to claim 44, further comprising a locking element configured for releasably locking said cover element in said closed position when said locking element is in engagement with said cover element.
